(19) United States
(12) Patent Application Publication
(10) Pub. No.: US 2010/0044366 A1
(43) Pub. Date: Feb. 25, 2010

(54) HEATING MAT USING FOUR HEAT SECTIONS

(76) Inventor: Kyung Yeon KIM, SEOUL (KR)

Correspondence Address: IPLA P.A., 3550 WILSHIRE BLVD., 17TH FLOOR, LOS ANGELES, CA, 90010, US

(21) Appl. No.: 12/196,163

(22) Filed: Aug. 21, 2008

(51) Int. Cl. H05B 3/34

(52) U.S. Cl. 219/528

(57) ABSTRACT

Disclosed herein is a heating mat using four heating sections. The heating mat includes a left heat generation unit, a right heat generation unit, a negative potential generation device, and an operation unit. The left heat generation unit includes first and second heating wires, which are respectively mounted in the left upper and left lower portions of the mat with respect to the central point of the mat. The right heat generation unit includes third and fourth heating wires, which are respectively mounted in the right upper and right lower portions of the mat with respect to the central point of the mat. The negative potential generation device generates a negative potential. The operation unit is electrically connected with the left and right heat generation units on one side of the mat.

### BACKGROUND OF THE INVENTION

1. Field of the Invention

The present invention relates generally to a heating mat using four heating sections and, more particularly, to a heating mat using four heating sections, which enables heating operations, heating periods and temperatures for individual portions of the mat not only to be freely adjusted but also to be easily viewed using both four heating wires, which are respectively mounted in the left upper and left lower portions and the right upper and right lower portions of the mat with respect to the central point of the mat, and an operation unit for individually controlling heating operations for the respective heating wires, thus not only allowing convenient use but also reducing the consumption of power, and which not only can alleviate muscular pain but also can improve blood circulation using a negative potential generation unit, thus being helpful to improving the health of a user.

2. Description of the Related Art

Generally, in order to warm a mat, a single heating element is inserted into the mat. However, it is impossible to adjust temperatures for respective portions of the mat because only a single heating element is inserted in the mat. Accordingly, an alternative heating mat using a plurality of heating elements, that is, heating wires, which are separated from each other so as to individually heat the portions of the mat, is used.

FIG. 1 is a perspective view showing a conventional heating mat.

The conventional heating mat is internally divided into an upper portion, a middle portion and a lower portion, and includes first, second and third heating wires 101, 102 and 103, which are arranged in the respective portions. The first, second and third heating wires 101, 102 and 103 are connected to a single operation unit 105 such that the temperatures of the respective wires are individually controlled.

However, the conventional heating mat, which is constructed as described above, is problematic in that it is difficult to accurately set the temperature desired by a user because the temperature is adjusted only to several predetermined levels, and in that the use thereof is inconvenient because the temperature is controlled only in the longitudinal direction of the mat but the temperatures of the left and right portions of the heating mat cannot be individually controlled according to the characteristics of the user's body.

Furthermore, the conventional heating mat is provided with no heating timer, so that the heating operation is continuously performed until the user turns off power even in case where use of the mat is not necessary, and thus consumption power is wasted.

### SUMMARY OF THE INVENTION

Accordingly, the present invention has been made keeping in mind the above problems occurring in the prior art, and the present invention is directed to provide a heating mat using four heating sections, which enables heating operations, heating periods and temperatures for individual portions of the mat not only to be easily viewed but also to be freely adjusted using both four heating wires, which are respectively mounted in the left upper and left lower portions and the right upper and right lower portions of the mat with respect to the central point of the mat, and an operation unit for individually controlling heating operations for the respective heating wires, thus allowing convenient use by a user and, in addition, reducing the consumption of power by selectively interrupting the supply of power to the portions of the mat which are to be unused.

Furthermore, the present invention is directed to provide a heating mat using four heating sections, which not only can alleviate muscular pain but also can improve blood circulation using a negative potential generation unit, thus being helpful to improving the health of the user.

The present invention provides a heating mat using four heating sections, including: a left heat generation unit including first and second heating wires, which are respectively mounted in the left upper and left lower portions of the mat with respect to the central point of the mat; a right heat generation unit including third and fourth heating wires, which are respectively mounted in the right upper and right lower portions of the mat with respect to the central point of the mat; a negative potential generation device for generating a negative potential; and an operation unit electrically connected with the left and right heat generation units on one side of the mat; wherein: temperatures for respective portions of the mat is controlled by the manipulation of operation unit, the operation unit comprises: left and right power switches for operating left and right heat generation units; left and right time setting units including left and right time adjustment switches for setting the operating periods of respective left and right heat generation units, and left and right heating time indication units for indicating heating periods in response to the manipulation of the left and right time adjustment switches; a left temperature adjustment unit including first and second temperature adjustment switches, which are disposed on the upper and lower sides of the left time adjustment switch, first and second operation lamps, which are configured to indicate whether heating operations are performed on the respective first and second wires, and first and second display units, which are configured to display respective adjusted temperatures; a right temperature adjustment unit including third and fourth temperature adjustment switches, which are disposed on the upper and lower sides of the right time adjustment switch, third and fourth operation lamps, which are configured to indicate whether heating operations are performed on third and fourth wires, and third and fourth display units, which are configured to display respective adjusted temperatures; and a negative potential generation unit including a negative potential switch for operating the negative potential generation device, and setting the operating period of the negative potential device, negative potential time lamps for indicating a set period in response to the manipulation of the negative potential switch, and a negative potential operation lamp for indicating the operation of the negative potential device; the left and right heat generation units are manufactured using carbon heating wires, each of the left and right heating time indication units comprises three lamps each for indicating three, five and eight hours, the first, second, third and fourth temperature adjustment switches are configured such that the temperature is maintained in a range of 30° C.˜70° C. and such that the temperature is increased by the increment of 1° C. whenever each of the temperature adjustment switches is pressed, the negative potential time lamps comprise four lamps for indicating one, three, five and seven hours, and the left and right heating time indication units are configured such that the respective three lamps are turned on one by one to indicate heating periods when the respective left or right time adjustment switches are repeatedly pressed and such that all of the respective three lamps are turned on and an infinite period is set when the respective left or right time adjustment switches are pressed four times, the first, second, third and fourth temperature adjustment switches are configured such that the supply of power to a respective heat generation unit is interrupted when each of the first, second, third and fourth temperature adjustment switches is pressed at a temperature of 70° C., and the negative potential time lamps are configured to be turned on one by one so as to indicate a negative potential generation period when the negative potential switch is repeatedly pressed, and to be turned off by the interruption of the supply of power when the negative potential switch is pressed five times.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional heating mat;

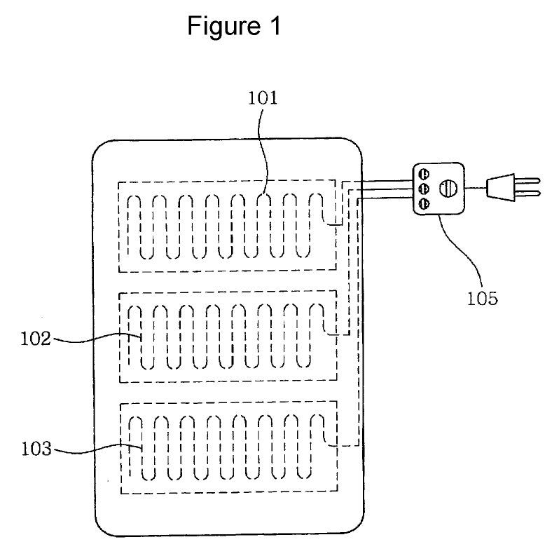

FIG. 2 is a perspective view showing a heating mat using four heating sections according to the present invention; and

FIG. 3 is a front view showing an operation unit according to the present invention.

### DESCRIPTION OF THE PREFERRED EMBODIMENTS

A heating mat using four heating sections according to the present invention is described in detail with reference to the accompanying drawings below.

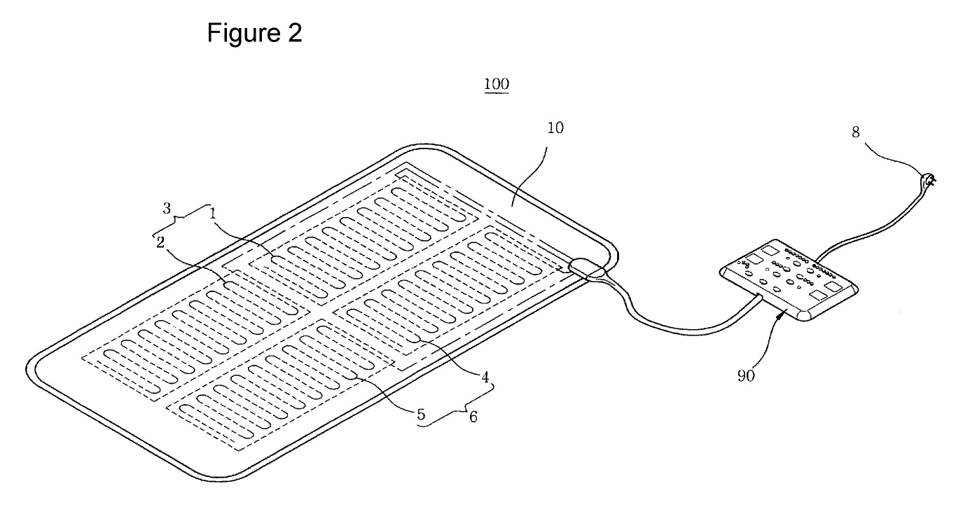

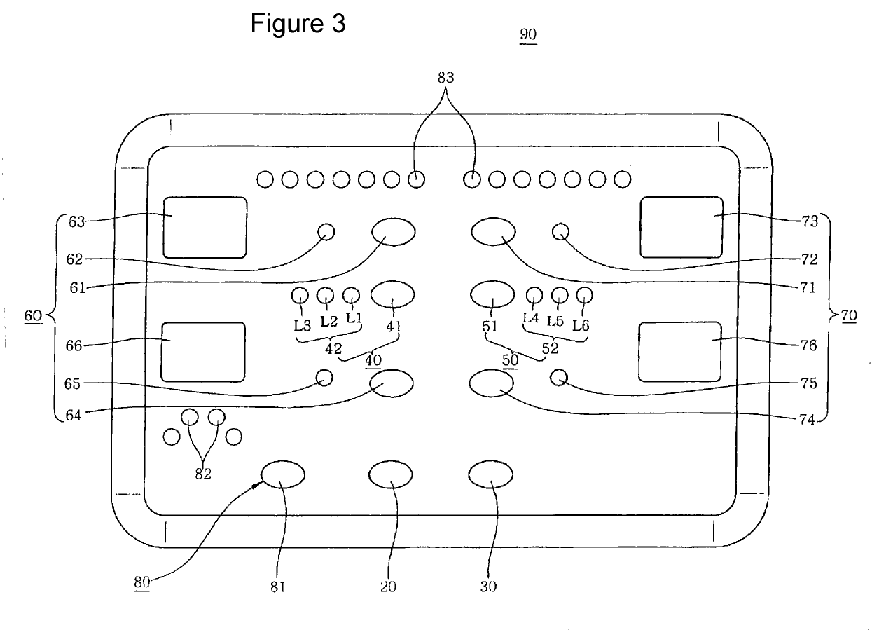

FIG. 2 is a perspective view showing a heating mat using four heating sections according to the present invention, and FIG. 3 is a front view showing an operation unit according to the present invention.

The heating mat using four heating sections according to the present invention includes a left heat generation unit 3 including first and second heating wires 1 and 2, which are respectively mounted in the left upper and left lower portions of the mat 10 with respect to the central point of the mat 10, a right heat generation unit 6 including third and fourth heating wires 4 and 5, which are respectively mounted in the right upper and right lower portions of the mat 10 with respect to the central point of the mat 10, a negative potential generation device for generating a negative potential, and an operation unit 90 electrically connected with the left and right heat generation units 3 and 6 on one side of the mat 10. In the heating mat using four heating sections according to the present invention, temperatures for respective portions of the mat 10 are adjusted by the manipulation of the operation unit 90.

It is preferred that the left and right heat generation units 3 and 6 be manufactured using carbon heating wires, which have an excellent power saving capabilities and radiates only a small amount of electromagnetic waves. It is preferred that the mat 10 be made of material containing far infrared ray producing material (not shown) so as to radiate far infrared rays.

Furthermore, the operation unit 90, which is electrically connected with the left and right heat generation units 3 and 6 to control the temperatures for the respective portions of the mat 10 as described above, includes left and right power switches 20 and 30, left and right time setting units 40 and 50, a left temperature adjustment unit 60, a right temperature adjustment unit 70, and a negative potential generation unit 80.

First, the left power switch 20 is electrically connected to the left heat generation unit 3, which includes the first and second heating wires 1 and 2, which are respectively mounted in the left upper and left lower portions with respect to the central point of the mat 10, and is responsible for operating the left heat generation unit 3.

Furthermore, the right power switch 30 is electrically connected to the right heat generation unit 6, which includes the third and fourth heating wires 4 and 5, which are respectively mounted in the right upper and right lower portions with respect to the central point of the mat 10, and is responsible for operating the right heat generation unit 6.

Furthermore, the left time setting unit 40 is used to set the operating period of the left heat generation unit 3 and is operated only when the left power switch 20 enters an ON-state. The left time setting unit 40 includes a left time adjustment switch 41 for setting the operating period, and a left heating time indication unit 42 for indicating the heating periods, which have been set, in response to the manipulation of the left time adjustment switch 41.

The left heating time indication unit 42 includes three lamps L1, L2 and L3 for indicating three, five and eight hours. When the left time adjustment switch 41 is repeatedly pressed, the three lamps L1, L2 and L3 are turned on one by one in order, and thus the corresponding heating period is indicated. When the left time adjustment switch 41 is pressed four times, all of the three lamps L1, L2 and L3 are turned on and an infinite period is set.

In this case, when the left time adjustment switch 41 is pressed one more time in the state in which an infinite period has been set as described above, a period of three hours is set, and thus only the corresponding lamp L1 is turned on.

Furthermore, the right time setting unit 50 is used to set the operating period of the right heat generation unit 6 and is operated only when the right power switch 30 enters in an ON-state. The right time setting unit 50 includes a right time adjustment switch 51 for setting the operating period, and a right heating time indication unit 52 for indicating the heating periods, which have been set, in response to the manipulation of the right time adjustment switch 51.

The right heating time indication unit 52 includes three lamps L4, L5 and L6 for indicating three, five and eight hours. When the right time adjustment switch 51 is repeatedly pressed, the three lamps L4, L5 and L6 are turned on one by one in order, and thus the corresponding heating period is indicated. When the left time adjustment switch 51 is pressed four times, all of the three lamps L4, L5 and L6 are turned on and an infinite period is set.

In this case, when the left time adjustment switch 51 is pressed one more time in the state in which an infinite period has been set as described above, a period of three hours is set, and thus only the corresponding lamp L4 is turned on.

Furthermore, the left temperature adjustment unit 60 is used to adjust the temperature of the left heat generation unit 3 when the left power switch 20 enter an ON-state, and includes first and second temperature adjustment switches 61 and 64, which are formed on the respective upper and lower sides of the left time adjustment switch 41 to adjust the temperatures of the first and second heating wires 1 and 2, first and second operation lamps 62 and 65 for indicating whether heating operations are performed on the respective first and second heating wires 1 and 2 according to the temperature adjustment, first and second display units 63 and 66 for displaying the respective adjusted temperatures.

The first and second temperature adjustment switches 61 and 64, which are provided in the left temperature adjustment unit 60, are configured such that the temperature is adjusted in a range of 30° C.˜70° C. and such that the temperature is increased by the increment of 1° C. whenever either of the temperature adjustment switches 61 and 64 is pressed. When the first and second temperature adjustment switches 61 and 64 are pressed at a temperature of 70° C., the supply of power is interrupted, and thus the operations of the respective left display units 63 and 66 are stopped and, at the same time, the heating operations for the first and second heating wires 1 and 2 of the left heat generation unit 3 are stopped.

In this case, when the first and second temperature adjustment switches 61 and 64 are pressed one more time in the state in which the supply of power to the first and second heating wires 1 and 2 of the left heat generation unit 3 is interrupted as described above, the heating operations are performed on the first and second heating wires 1 and 2 of the left heat generation unit 3 again to generate heat sufficient to maintain a temperature of 30° C., and the left display units 63 and 66 are turned on again to display the temperature of 30° C.

Furthermore, the right temperature adjustment unit 70 is used to adjust the temperature of the right heat generation unit 6 when the right power switch 30 enter an ON-state, and includes third and fourth temperature adjustment switches 71 and 74, which are formed on the respective upper and lower sides of the right time adjustment switch 51 to adjust the temperatures of the third and fourth heating wires 4 and 5, third and fourth operation lamps 72 and 75 for indicating whether heating operations are performed on the respective third and fourth heating wires 4 and 5 according to the temperature adjustment, and third and fourth display units 73 and 76 for displaying the respective adjusted temperatures.

The third and fourth temperature adjustment switches 71 and 74, which are provided in the right temperature adjustment unit 70, are configured such that the temperature is adjusted in a range of 30° C.˜70° C. and such that the temperature is increased by the increment of 1° C. whenever each of the temperature adjustment switches 71 and 74 is pressed. When the third and fourth temperature adjustment switches 71 and 74 are pressed at a temperature of 70° C., the supply of power is interrupted, and thus the operations of the respective right display units 73 and 76 are stopped and, at the same time, the heating operations for the third and fourth heating wires 4 and 5 of the right heat generation unit 6 are stopped.

In this case, when the third and fourth temperature adjustment switches 71 and 74 are pressed one more time in the state in which the supply of power to the third and fourth second heating wires 4 and 5 of the right heat generation unit 6 is interrupted as described above, the heating operations are performed on the third and fourth heating wires 4 and 5 of the right heat generation unit 6 again to generate heat sufficient to maintain a temperature of 30° C., and the right display units 73 and 76 are turned on again to display the temperature of 30° C.

Furthermore, the negative potential generation unit 80 is used to adjust the ON/OFF of a power source and a negative potential generation period, and includes a negative potential switch 81 for operating a negative potential generation device (not shown), which is provided in the mat 10, and setting the operating period of the negative potential generation device, negative potential time lamps 82 for indicating the set period in response to the manipulation of the negative potential switch 81, and a negative potential operation lamp 83 for indicating whether the negative potential generation device is operated.

The negative potential time lamps 82 include four lamps for indicating one, three, five and seven hours. When the negative potential switch 81 is repeatedly pressed, the negative potential time lamps 82 are turned on one by one in order, and thus the corresponding negative potential generation period is indicated. When the negative potential switch 81 is pressed five times, the supply of power is interrupted, and thus the negative potential time lamps 82 are turned off and, at the same time, the operation of the negative potential generation device is stopped.

The operation of the heating mat using four heating sections, which is constructed as described above, is described below.

First, a plug 8, which is provided by the operation unit 90, is connected to an outlet (not shown) after the heating mat 100 using four heating sections has been disposed on a floor, in order to supply electricity to the operation unit 90.

Thereafter, when the left and right power switches 20 and 30, which are provided in the operation unit 90, are pressed, power is supplied to the first, second, third and fourth heating wires 1, 2, 4 and 5, which are respectively mounted in the left upper and left lower portions and right upper and right lower portions of the mat 10 with respect to the central point of the mat 10, and heating operations are performed on the heating wires 1, 2, 4 and 5.

In this case, the left and right power switches 20 and 30 is individually manipulated, so that the heating wires 1, 2, 4 and 5, which are mounted in the left and right portions of the mat 10, can be selectively operated, and thus the mat can be freely used according to a user's convenience, such as meeting the particular characteristics of the user's body.

After the left and right power switches 20 and 30 are manipulated as described above, when the left and right time adjustment switches 41 and 51, provided in the left and right time setting units 40 and 50, are pressed, the heating periods can be adjusted and can also be viewed through the left and right heating time indication units 42 and 52. This function can be effectively used when it is desired to automatically interrupt the supply of power such as for sleeping or going-out.

Here, the left heating time indication unit 42 includes three lamps L1, L2 and L3, and the right heating time indication unit 52 includes three lamps L4, L5 and L6. Accordingly, when the left and right time adjustment switches 41 and 51 are repeatedly pressed, it is indicated that heating is sequentially performed for three, five and eight hours. When the left and right time adjustment switches 41 are 51 are pressed in the state in which the lamps L3 and L4 for indicating eight hours are turned on, all of the lamps L1, L2, L3, L4, L5 and L6 are turned on and, at the same time, an infinite period is set. In this state, when the left and right time adjustment switches 41 and 51 are pressed one more time, the lamps L1 and L4 for indicating three hours are turned on again.

After a setting is made using the left and right time setting units 40 and 50 as described above, when the first, second, third and fourth temperature adjustment switches 61, 64, 71 and 74, provided in the left and right temperature adjustment units 60 and 70, are manipulated, the temperatures can be adjusted, the heating operations can be viewed through the first, second, third and fourth operation lamp 62, 65, 72 and 75 for indicating whether heating operations are performed on the respective heating wires 1, 2, 4 and 5 according to the adjustment of temperature, and the temperatures can be viewed through the first, second, third and fourth display units 63, 66, 73 and 76 for displaying respective temperature settings.

In this case, the first, second, third and fourth temperature adjustment switches 61, 64, 71 and 74 are configured such that the temperature is maintained in a range of 30° C.˜70° C. and such that the temperature is increased by the increment of 1° C. whenever each of the first, second, third and fourth temperature adjustment switches 61, 64, 71 and 74 is pressed one time. When the first, second, third and fourth temperature adjustment switches 61, 64, 71 and 74 are pressed at a temperature of 70° C., the supply of power to the heating wires 1, 2,4 and 5 is interrupted, and thus the heating operations for the heating wires 1, 2, 4 and 5 are stopped and, at the same time, the corresponding display units 63, 66, 73 and 76 are turned off.

In addition, when the first, second, third and fourth temperature adjustment switches 61, 64, 71 and 74 are pressed one more time in the state in which the supply of power to the heating wires 1, 2, 4 and 5 of the left and right heat generation units 3 and 6 is interrupted, the heating wires 1, 2, 4 and 5 of the left and right heat generation units 3 and 6 are operated again to generate heat sufficient to maintain a temperature of 30° C., and the corresponding display units 63, 66, 73 and 76 are turned on again to display 30° C.

As described above, the left and right temperature adjustment units 60 and 70 enables the supply of power as well as setting of the heating temperatures of the first, second, third and fourth heating wires 1, 2, 4 and 5 in response to the manipulation of the first, second, third and fourth temperature adjustment switches 61, 64, 71 and 74, so that the user can conveniently use the heating mat 100 using four heating sections under any desired optimized condition, and the consumption of power can be reduced because the supply of power to only portions of the mat, which are to be unused, can be selectively interrupted.

Furthermore, the negative potential generation unit 80 is used to operate the negative potential generation device, which is mounted in the mat 10, regardless of the manipulation of the left and right power switches 20 and 30, when the negative potential switch 81 is pressed, and is also used regardless of the season. When this unit is used, the health benefits, such as the alleviation of muscular pain and the improvement of blood circulation, can be provided to the user.

The heating mat using four heating sections according to the present invention is advantageous in that it enables heating operations, heating periods and temperatures for individual portions of the mat not only to be easily viewed but also to be freely adjusted using both the four heating wires, which are respectively mounted in the left upper and left lower portions and the right upper and right lower portions of the mat with respect to the central point of the mat, and the operation unit for individually controlling heating operations for the respective heating wires, thus providing convenience in use to a user and, in addition, reducing the consumption of power by selectively interrupting the supply of power to portions of the mat which are to be unused.

Furthermore, the present invention not only can alleviate muscular pain but can also improve blood circulation using a negative potential generation unit, thus being helpful to improving the health of the user.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A heating mat using four heating sections, comprising:
a left heat generation unit comprising first and second heating wires, which are respectively mounted in left upper and left lower portions of the mat with respect to a central point of the mat;
a right heat generation unit comprising third and fourth heating wires, which are respectively mounted in right upper and right lower portions of the mat with respect to the central point of the mat;
a negative potential generation device for generating a negative potential; and
an operation unit electrically connected with the left and right heat generation units on one side of the mat;
wherein:
temperatures for respective portions of the mat is controlled by manipulation of operation unit,
the operation unit comprises: left and right power switches for operating left and right heat generation units; left and right time setting units comprising left and right time adjustment switches for setting operating periods of respective left and right heat generation units, and left and right heating time indication units for indicating heating periods in response to manipulation of the left and right time adjustment switches; a left temperature adjustment unit comprising first and second temperature adjustment switches, which are disposed on upper and lower sides of the left time adjustment switch, first and second operation lamps, which are configured to indicate whether heating operations are performed on the respective first and second wires, and first and second display units, which are configured to display respective adjusted temperatures; a right temperature adjustment unit comprising third and fourth temperature adjustment switches, which are disposed on upper and lower sides of the right time adjustment switch, third and fourth operation lamps, which are configured to indicate whether heating operations are performed on third and fourth wires, and third and fourth display units, which are configured to display respective adjusted temperatures; and a negative potential generation unit comprising a negative potential switch for operating the negative potential generation device, and setting an operating period of the negative potential device, negative potential time lamps for indicating a set period in response to manipulation of the negative potential switch, and a negative potential operation lamp for indicating operation of the negative potential device;
the left and right heat generation units are manufactured using carbon heating wires,
each of the left and right heating time indication units comprises three lamps each for indicating three, five and eight hours,
the first, second, third and fourth temperature adjustment switches are configured such that the temperature is maintained in a range of 30° C.˜70° C. and such that the temperature is increased by an increment of 1° C. whenever each of the temperature adjustment switches is pressed,
the negative potential time lamps comprise four lamps for indicating one, three, five and seven hours, and
the left and right heating time indication units are configured such that the respective three lamps are turned on one by one to indicate heating periods when the respective left or right time adjustment switches are repeatedly pressed and such that all of the respective three lamps are turned on and an infinite period is set when the respective left or right time adjustment switches are pressed four times,
the first, second, third and fourth temperature adjustment switches are configured such that a supply of power to a respective heat generation unit is interrupted when each of the first, second, third and fourth temperature adjustment switches is pressed at a temperature of 70° C., and
the negative potential time lamps are configured to be turned on one by one so as to indicate a negative potential generation period when the negative potential switch is repeatedly pressed, and to be turned off by interruption of the supply of power when the negative potential switch is pressed five times.
